(19) United States
(12) Patent Application Publication
(10) Pub. No.: US 2001/0053339 A1
(43) Pub. Date: Dec. 20, 2001

(54) Separation of metal chlorides from gaseous reaction mixtures from the synthesis of chlorosilane

(75) Inventors: Bernd Kohler, Leckwitz (DE); Eberhard Schulz, Riesa (DE); Bernd Vendt, Oer-Erkenschwick (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Degussa AG, Dueseldorf (DE)

(21) Appl. No.: 09/884,151

(22) Filed: Jun. 20, 2001

(30) Foreign Application Priority Data
Jun. 20, 2000 (DE) 10 030 251.3

(51) Int. Cl. C01B 9/02; B01D 37/00; B01D 53/00

(52) U.S. Cl. 422/168; 423/491; 423/342; 422/173; 422/171

(57) ABSTRACT

A process for separating metal chlorides from the hot, gaseous reaction mixture (crude gas) formed in the reaction of technical-grade silicon with hydrogen chloride, in which the crude gas is introduced into a circulated suspension of metal chlorides in chlorosilanes, the temperature of the crude gas is reduced from its introduction temperature to the temperature of the three-phase gas/liquid/solid mixture formed on introduction of the crude gas into the suspension partly by direct cooling resulting from vaporization of chlorosilanes and partly by indirect cooling, part of the resulting suspension of metal chlorides in liquid chlorosilanes is recirculated to the introduction point of the crude gas and the metal chlorides are separated from the other part of the suspension. The invention also relates to an apparatus (or condenser) in which the crude gas is introduced into a suspension of metal chlorides in chlorosilanes to separate out metal chlorides and chlorosilanes, and to a filtration and dissolution apparatus for separating the suspension of metal chlorides in chlorosilanes and for further treatment of the metal chlorides which have been separated off.

### BACKGROUND OF THE INVENTION

1. Field Of The Invention

The invention relates to a process for separating metal chlorides from the gaseous reaction mixtures formed in the reaction of technical-grade silicon and hydrogen chloride, and to the treatment of the metal chlorides which have been separated off to give a solution of metal chlorides in aqueous hydrochloric acid. The invention further relates to an at apparatus (or condenser) in which the crude gas is passed into a suspension of metal chlorides in chlorosilanes so as to separate out metal chlorides and chlorosilanes, and also to a filtration and dissolution apparatus for separating the suspension of metal chlorides in chlorosilanes and for the further treatment of the metal chlorides which have been separated off.

2. Discussion Of The Background

It is known that technical-grade silicon containing metallic impurities can be reacted with hydrogen chloride at temperatures of from 270° to 1,000° C. both in fixed-bed reactors and in fluidized-bed reactors to form chlorosilanes. This process gives a gaseous reaction mixture which consists predominantly, depending on the reaction temperature, of a mixture of trichlorosilane and tetrachlorosilane (silicon tetrachloride). The metallic impurities in the silicon, mainly iron, aluminum and calcium, are converted into the corresponding chlorides. A portion of these chlorides is carried from the reactor together with fine silicon dust whose amount varies greatly depending on the reactor type and throughput, and is deposited in cyclones or filtration units located downstream of the reactor. In particular, calcium chloride and iron chloride are predominantly deposited as solid metal chlorides on the fine silicon particles on cooling the gaseous reaction mixture and can thus easily be carried out with the dust. The remainder of the metal chlorides, predominantly aluminum chloride, remain in vapor form in the cooled gaseous reaction mixture.

Aluminum chloride in particular tends to be deposited in solid form in pipes, on cooling surfaces or other equipment surfaces at temperatures below about 150° C., which have to be employed for condensing the chlorosilanes under atmospheric pressure. The prior art therefore provides various solutions for carrying out the condensation of the chlorosilanes in a trouble-free manner despite this tendency for deposition of solid and to separate off the aluminum chloride present as elegantly as possible. In a known process, the condensation is carried out in a first stage by indirect cooling, usually by means of water as the cooling medium, in upright shell-and-tube heat exchangers through which the gaseous reaction mixture comprising metal chlorides flows from the bottom upward. The condensate which flows downward is supposed to flush away the metal chloride which is precipitated as a solid and keep the heat-exchange surfaces free. To avoid blockages at the gas inlet, “knock-off” devices are often installed at these particularly critical points so as to keep the flow cross section free for as long as possible. The suspensions of metal chlorides in chlorosilanes formed by condensation have to be treated to separate off the metal chlorides.

According to DE 629 853, the gaseous reaction mixture containing metal chlorides is passed into a melt which comprises an aluminum chloride/alkali metal chloride mixture that largely holds back, aluminum chloride and iron chloride. The chlorosilanes are isolated by condensation of the vapors which are largely free of metal chlorides.

In a further known process employing indirect cooling, the gaseous reaction mixture containing metal chlorides is passed through a simple double-walled condenser. This process also gives a suspension of metal chlorides in chlorosilanes from which the metal chlorides have to be separated. However, a portion of the metal chlorides gradually forms a growing deposit on the cooling surfaces, as a result of which the flow cross-section is correspondingly reduced. When a particular fill level has been reached, the reaction mixture is switched over to a similar parallel condenser, the metal chloride deposit is removed by flushing with water and the condenser is subsequently dried. This operation is associated with frequent removal and reinstallation of the condenser, but still allows pseudocontinuous operation.

Finally, a continuous process in which the gaseous reaction mixture containing metal chlorides is passed into liquid chlorosilanes and the precipitated solid metal chlorides are separated from the liquid chlorosilanes is known. In a particular embodiment of this process, the gaseous reaction mixture containing metal chlorides (crude gas) having a temperature which may, for example, be about 300° C. is brought into intimate contact with a vertically directed, finely divided stream of chlorosilanes. The chlorosilanes used are advantageously the reaction product of a chlorosilane synthesis, which is used, for example, at a temperature of from 40 to 50° C. A part of the chlorosilanes (particularly the low-boiling trichlorosilane) is vaporized, the crude gas is appropriately cooled and the metal chlorides separate out as solids in the liquid chlorosilanes. The mixture of cooled crude gas and liquid chlorosilanes containing metal chlorides is passed to a separation vessel from whose upper part the gas phase laden predominantly with relatively low-boiling chlorosilane vapors, is taken off. From the bottom part of the separation vessel, part of the liquid chlorosilane phase enriched in the higher-boiling chlorosilanes and containing the suspended metal chlorides is taken off. The metal chlorides are separated off and the liquid phase is worked up by distillation to isolate chlorosilanes. Another part of the liquid chlorosilane phase is introduced as runback into a column in which the entrained chlorosilanes are substantially scrubbed out from the above-mentioned gas phase laden predominantly with relatively low-boiling chlorosilanes. From the remaining gas phase, the predominantly relatively low-boiling chlorosilanes which are always still present therein in considerable amounts are condensed out by lowtemperature cooling and part of them is worked up by distillation to isolate chlorosilanes, if desired together with the chlorosilane phase which has been taken off from the lower part of the separation vessel and has been freed of metal chlorides, and the other part is returned as runback to the abovementioned column.

If the crude gas is cooled indirectly in the processes of the prior art, it is necessary to take the condensers out of operation after only a relatively short operating time because of unsatisfactory cooling performance as a result of metal chloride deposits, which can go so far as blockages. Cleaning of the condensers is laborious and problematical both in terms of environmental protection and in respect of safety. The combustible chlorosilane vapors first have to be removed carefully. Cleaning of the cooling surfaces by treatment of the chlorosilane-containing deposits with water then has to be carried out very carefully, since the hydration of the aluminum chloride can occur in an explosive manner. In addition, precautions have to be taken to avoid emissions of chlorosilanes and/or hydrogen chloride. The process of DE 629 853 has the disadvantage that the melt frequently has to be replaced, for which purpose part of the circulated melt is taken off continually or at frequent intervals and is worked up. The procedure involving introduction of the crude gas stream into liquid chlorosilane requires problematical circulation of large amounts of liquid chlorosilanes.

### BRIEF DESCRIPTION OF THE DRAWINGS

FIG. 1 schematically shows the process of the invention for separating metal chlorides from the gaseous reaction mixtures (crude gas) formed in the reaction of technicalgrade silicon metal with hydrogen chloride.

FIG. 2 shows a suitable apparatus in which a substep of the process mentioned, namely introduction of the crude gas into a suspension of metal chlorides in liquid chlorosilane and also indirect cooling of the three-phase mixture formed, is carried out.

FIG. 3 shows a possible configuration of the filtration and dissolution apparatus by means of which the suspended metal chlorides are separated from the liquid chlorosilanes and converted into an aqueous solution in a further substep of the process.

### SUMMARY OF THE INVENTION

It is an object of the invention to provide a process by which metal chlorides can be separated reliably from the gaseous reaction mixture of the synthesis of chlorosilanes from technical-grade silicon containing metallic impurities and hydrogen chloride, having long operating times and without frequent production interruptions, which process requires no complicated replacement and work-up of metal salt melts and avoids the circulation of large amounts of chlorosilanes.

The invention provides an advantageous process for separating metal chlorides from the hot, gaseous reaction mixture (crude gas) formed in the reaction of technical-grade silicon with hydrogen chloride, in which the crude gas is introduced into a circulated suspension of metal chlorides in chlorosilanes, the temperature of the crude gas is reduced from its introduction temperature to the temperature of the three-phase gas/liquid/solid mixture formed on introduction of the crude gas into the suspension partly by direct cooling resulting from vaporization of chlorosilanes and partly by indirect cooling, part of the resulting suspension of metal chlorides in liquid chlorosilanes is recirculated to the introduction point of the crude gas and the metal chlorides are separated from the other part of the suspension. This separation is advantageously carried out under pressure in a filtration apparatus.

The invention also provides a process in which the metal chlorides are separated from a suspension in chlorosilanes, by separating them into a solid phase and a liquid phase in the absence of air and moisture in a zone which has been made inert, advantageously under pressure. The solid phase is broken up in a zone which has been made inert, the broken-up solid phase is passed to a dissolution zone in which the metal chlorides are dissolved to form an aqueous metal chloride solution, and the individual chlorosilanes are isolated from the liquid phase by distillation.

The invention further provides an apparatus (or condenser) in which the condensation of the chlorosilanes and the metal chlorides in the crude gas takes place and which comprises a hollow vessel 17 having a preferably cylindrical cross section and preferably a conical taper in the lower part; an external circulation pipe 18; a crude gas inlet port 19; a heat exchanger 20 located in the hollow vessel 17; an overflow port 21 and a gas offtake port 22.

The invention further provides a filtration and dissolution apparatus by means of which solid metal chlorides suspended in liquid chlorosilanes are separated off and can be converted into an aqueous solution, which comprises a gastight filtration chamber 12; a filtration apparatus 6 enclosed therein; a feed line for the suspension 5; an offtake for liquid chlorosilanes 7; an inert gas lock 13; a granulator 14 for breaking up the filter cake 8; a conveying device 15 for the granulated filter cake 8; a dissolution vessel 9 having a feed line 16 for water or hydrochloric acid and an offtake for the acidic metal salt solution 11.

### DESCRIPTION OF THE PREFERRED EMBODIMENTS

Feedstocks employed are the gaseous reaction mixtures (crude gas) from known reactions of technical-grade silicon with hydrogen chloride. The silicon dust obtained and also part of the metal chlorides can be separated out before the crude gas is treated according to the invention. If this separation step is omitted, silicon dust is additionally present in the suspension of the metal chlorides in chlorosilanes. The crude gas generally contains, depending on the reaction conditions, from 2 to 50% by weight of unreacted hydrogen chloride. The remainder is composed predominantly of hydrogen and chlorosilanes, among which trichlorosilane and tetrachlorosilane (silicon tetrachloride) in turn make up by far the major part. In addition, apart from iron(III) chloride and calcium chloride, especially the problematical (because it is relatively volatile and difficult to condense) aluminum chloride is present. The metal chloride content of the gaseous reaction mixtures is generally from 0.1 to 4% by weight, based on chlorosilanes. Silicon dust may be present in amounts of from 1 to 5% by weight, based on chlorosilanes.

The process of the invention can be carried out semicontinuously, with the crude gas being passed continuously into the liquid chlorosilanes and the suspension of the metal chlorides in the chlorosilanes being separated batchwise, e.g., in a filter press or by means of a candle filter. In this case, it is possible to provide a buffer vessel in which the suspension is collected while the filter is being emptied. Alternatively, two filters can be arranged in parallel so that one filters the suspension while the other is being emptied. The process of the invention can also be carried out fully continuously by using, for example, a trailing blade centrifuge as separation apparatus for the suspension.

The process of the invention is generally carried out under atmospheric pressure or under superatmospheric pressure up to about 5 bar. The crude gas generally enters the process, if desired after precooling, at a temperature (introduction temperature) of from 135 to 200° C.

According to the invention, the crude gas is introduced into a circulated suspension of metal chlorides in chlorosilanes. Chlorosilanes, i.e. trichlorosilane and tetrachlorosilane, are by far the major reaction products of the chlorosilane synthesis. The crude gas is advantageously introduced into the suspension at high velocity, preferably at such a velocity and in such an amount per unit time that a linear velocity of the gas/liquid/solid mixture formed is at least 2 m/s; preferably from 2 to 8 m/s results in the circuit. The circulation of the chlorosilanes can be effected by appropriately directed introduction of the crude gas (the system then operates according to the principle of an airlift pump) into the circulating liquid/solid mixture and of the resulting gas/liquid/solid mixture into the hollow vessel 17 of the condenser.

On introduction into the suspension of metal chlorides in liquid chlorosilanes, the crude gas is firstly cooled directly by vaporization, preferably of the relatively low-boiling chlorosilanes, in particular trichlorosilane, present in the circulated suspension of metal chlorides in liquid chlorosilanes. This results in condensation of part of the chlorosilanes present in the crude gas, in particular the relatively high-boiling silicon tetrachloride. Furthermore, the metal chlorides present in the crude gas separate out in solid form. The result is a three-phase mixture comprising a suspension of solids (metal chlorides and possibly silicon dust) in liquid chlorosilanes and the still gaseous constituents of the crude gas. This three-phase mixture then flows through a cooling zone having indirect cooling and subsequently separates into a gas phase comprising uncondensed chlorosilanes and the remaining gaseous constituents of the crude gas and a suspension of metal chlorides in chlorosilanes.

A boiling equilibrium exists in both cooling zones, so that the temperatures in the overall system, including the circulated suspension, are similar. When working under atmospheric pressure, they are generally from 30 to 60° C. The excess heat content of the crude gas and the heat of condensation of the liquefied chlorosilanes are finally removed by the indirect cooling, i.e. passed to the cooling liquid, generally water. The necessary amount per unit time and the temperature of the cooling liquid are matched appropriately; they can be calculated without difficulty from the relevant parameters of the crude gas, of the cooling liquid and of the heat exchanger which effects the indirect cooling.

It is an important feature of the process of the invention that the crude gas first comes into contact with liquid chlorosilanes (in which metal chlorides are suspended) and is directly cooled by vaporization, preferably of the low-boiling chlorosilanes, after which indirect cooling is carried out. Surprisingly, virtually no deposits of metal chlorides are formed on the cooling surfaces of the heat exchanger, let alone blockages, as occurs in the processes of the prior art which employ indirect cooling.

The gas phase separated from the suspension of metal chlorides in chlorosilanes still contains appreciable amounts of chlorosilanes, predominantly relatively volatile chlorosilanes, which can be condensed in a customary manner by single-stage or multistage cooling to temperatures as low as −70° C. and separated off. The remaining hydrogen chloride can be absorbed in water to form hydrochloric acid or be worked up in a customary manner by subsequent compression/condensation and distillation to give reusable hydrogen chloride. The hydrogen can be flared or employed for energy generation.

Owing to the density difference between the gas phase and the suspension of metal chlorides in chlorosilanes, the gas phase and suspension separate when the three-phase mixture mentioned enters the hollow vessel of the condenser and part of the suspension can be returned essentially without gaseous constituents to the introduction point of the crude gas. The metal chloride content of this suspension can vary within wide limits and is generally from 0.1 to 8% by weight. The suspension is, as mentioned above, advantageously recirculated at a linear velocity of from 2 to 8 m/s, as a result of which deposition of metal chlorides in the external circulation pipe 18 is avoided. The linear velocity can, as described above, be controlled by the solution which generally contains from 0.1 to 1.0% by weight of metal salt and can readily be passed to wastewater treatment.

Description of the process diagram, the apparatuses and equipment items

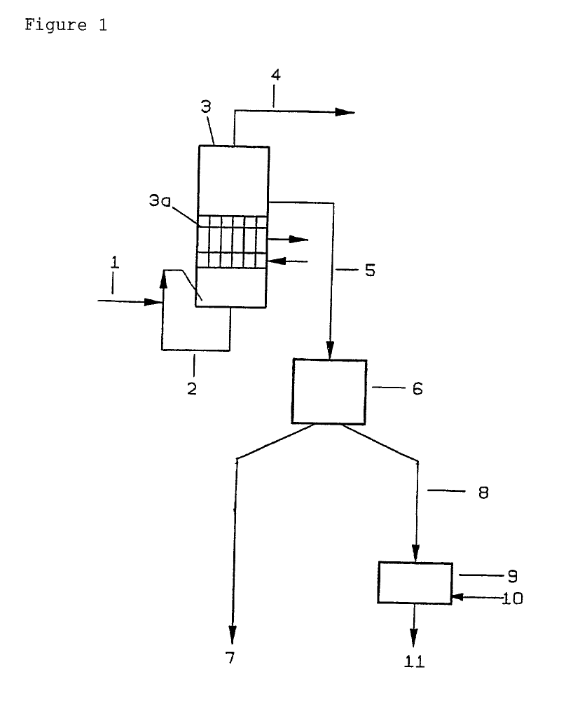

FIG. 1 shows a schematic flow diagram of the process of the invention. The crude gas 1 from the chlorosilane synthesis is introduced into the suspension of metal chlorides in liquid chlorosilanes which circulates in a circuit 2 located partly outside and partly within the condensation zone 3. In a heat exchange zone 3a within the condensation zone 3, the threephase mixture formed by introduction of the crude gas and comprising a suspension of metal chlorides in chlorosilanes together with uncondensed gaseous constituents of the crude gas 1 is cooled indirectly by means of a cooling fluid. Part of the suspension, which is largely free of gaseous constituents, is recirculated via the circuit 2 to the introduction point for the crude gas 1. In the upper part of the condensation zone 3, the still gaseous constituents 4 of the crude gas 1 separate from the suspension. The chlorosilanes present in the gaseous material 4 are separated off by low-temperature condensation (not shown).

The overflow 5 is the part of the suspension of metal chlorides in chlorosilanes which is worked up to isolate chlorosilanes. It is passed to the solid/liquid separation 6. The liquid phase 7 (chlorosilanes) is fractionated into the various chlorosilanes by distillation (not shown), advantageously together with the chlorosilanes recovered from the gaseous material by low-temperature condensation. The solid phase 8 (metal chlorides) goes to the dissolution zone 9 where it is introduced into water or aqueous hydrochloric acid 10. The aqueous solution of the metal salt 11 can be passed to wastewater treatment.

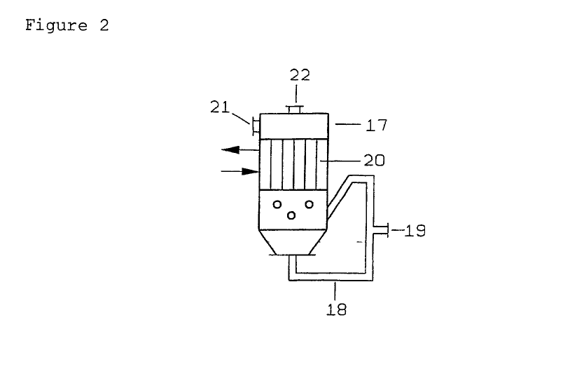

FIG. 2 shows an apparatus (or condenser) in which the introduction of the crude gas into the suspension of metal chlorides in chlorosilanes and the condensation of the chlorosilanes and the metal chlorides takes place and which comprises a hollow vessel 17 having a preferably cylindrical cross section and preferably a conical taper in the lower part. This hollow vessel can, like the other parts of the apparatus, be made of carbon steel. The vessel has an external circulation pipe 18 in which a suspension of metal chlorides in chlorosilanes circulates. The circulation pipe 18 is provided with an inlet port 19 for the crude gas which drives the circulation. The heat exchanger 20 is located in the hollow vessel 17 and cools the three-phase mixture which enters the hollow vessel 17 from the circulation pipe 18 by means of cooling water. In the upper part of the hollow vessel 17, gas and suspension separate. The suspension leaves the hollow vessel 17 via the overflow port 21 and the gas phase goes out via the gas offtake port 22.

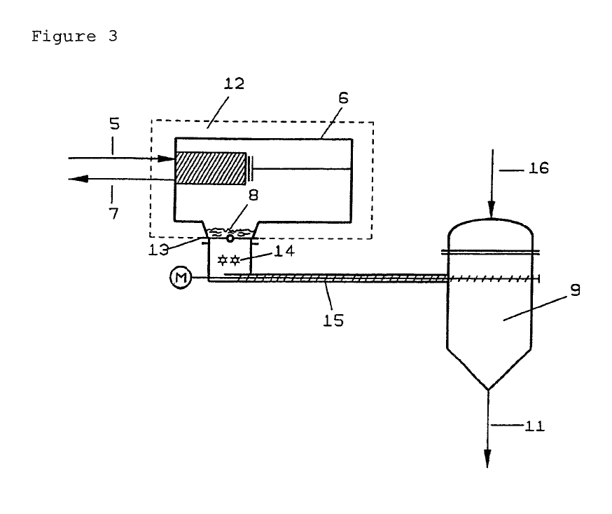

FIG. 3 illustrates a possible embodiment of a filtration and dissolution apparatus in a plant as shown in FIG. 1; this filtration and dissolution apparatus is also described in the simultaneously filed U.S. application based on German patent application 100 30 252, incorporated herein by reference. In the gastight filtration chamber 12, there is, as filtration apparatus 6, a filter press to which the suspension of metal chlorides in chlorosilanes obtained as overflow 5 is fed. Suitable filter presses are commercially available. In practice, the BHS Autopress from BHS, 87527 Sonthofen, Federal Republic of Germany, has been found to be useful. It has vertical, plate-shaped filter elements and is provided for the purposes of the invention with woven stainless steel mesh as filter material. The suspension is pumped into the spaces between the plates and the metal chlorides are collected on the outer sides of the filter plates, while the chlorosilanes 7 flow out as filtrate between spacers arranged between the filter plates. When the filter cake has filled the intermediate spaces between the plates, it is pressed and subsequently discharged mechanically. In the case of the BHS Autopress, all steps occur automatically.

The filter cake 8, which is quite solid as a result of pressing, is firstly passed via a lock 13 which has been made inert to a granulator 14. Suitable granulators are, for example, pin rolls. The granulated metal chloride is conveyed by means of a screw conveyor 15 to the dissolution vessel 9 which can be, for example, a stirred vessel which can be supplied with water or dilute hydrochloric acid via the feed line 16. The resulting acidic metal salt solution 11 is taken from the dissolution vessel 9 and can readily be passed to wastewater treatment.

The following examples are intended to illustrate the invention without limiting its scope.

### Example 1

The process is carried out as schematically shown in FIG. 1 using a condenser as shown in FIG. 2 and a filtration and dissolution apparatus as shown in FIG. 3. The crude gas 1 from a chlorosilane synthesis from technical-grade silicon and hydrogen chloride, which is at 135° C. and has a metal chloride content of 1.05 kg per 1,000 kg of chlorosilane, is fed in via the introduction port 19 and introduced into the liquid suspension 2 of metal chloride in chlorosilanes which circulates in the circulation pipe 18 and is at a temperature of 35° C. The three-phase mixture of the suspension of metal chlorides in liquid chlorosilane and uncondensed constituents of the crude gas introduced enters the hollow vessel 17 and flows through the heat exchanger 20 which is cooled by means of water at 23° C. and has a temperature of 34° C. at its end. There, the uncondensed constituents 4 of the crude gas 1 leave via the gas offtake port 22 and the chlorosilanes present therein are condensed by lowtemperature cooling down to −70° C.

The overflow 5 consisting of the suspension of metal chlorides in chlorosilanes and having a metal chloride content of 2.0 kg per 1,000 kg of chlorosilanes goes, at a temperature of 34° C., via the overflow port 21 to the encapsulated filter press 6 which has been made inert by means of nitrogen. The filter cake 8 obtained there has a metal chloride content of 51% by weight and is passed via the solids lock 13, the granulator 14 and the screw conveyor 15 to the dissolution vessel 9 which is supplied with about 1 cubic meter/h of water via the feed line 16. The aqueous metal salt solution 11 taken off from the dissolution vessel 9 has a metal chloride content of 0.30% by weight, a hydrogen chloride content of 0.23% by weight and contains small amounts of hydrolysis products of the chlorosilanes which were present in the filter cake. It is passed to wastewater treatment. The filtrate 7 together with the chlorosilanes separated out from the uncondensed proportion 4 of the crude gas 1 by low-temperature cooling is worked up by distillation.

Even after a number of years of operation, only a low level of deposits is present on the cooling surfaces and other parts of the plant and these deposits do not impair the function of the plant.

### Example 2

This is carried out essentially as described in example 1 However, the crude gas 1 is at a temperature of 145° C. and contains about 24 kg of metal chlorides and about 30 kg of unreacted silicon dust per 1,000 kg of chlorosilanes. The suspension of metal chlorides in chlorosilanes into which the crude gas is introduced after dry filtration has a temperature of 43° C. The crude gas is cooled to 46° C. within less than 1 second by direct cooling with the liquid chlorosilane. For this purpose, the heat exchanger 20 is supplied with 6 cubic meters/h of cooling water at 21° C.

The overflowing suspension 5 has a metal chloride content of 1.4 kg per 1,000 kg of chlorosilane and a temperature of 46° C. It is passed to a filter press 6 from which a filter cake 8 having a metal chloride content of about 85% by weight is ejected periodically. The filter cake is conveyed as described in example 1 to the dissolution apparatus 9 which is supplied with 1 cubic meter/h of water. The resulting aqueous solution 11, which has a metal chloride content of 0.24% by weight and a hydrogen chloride content of 0.04% by weight, is passed to a wastewater treatment plant.

The filtrate 7 together with the chlorosilanes separated out from the uncondensed proportion 4 of the crude gas 1 by multistage low-temperature condensation (down to −53° C.) is worked up by distillation.

Priority document DE 100 30 241.3, filed Jun. 6, 2000, is hereby incorporated by reference.

1. A process for separating metal chlorides from a hot, gaseous reaction mixture (crude gas) formed in the reaction of technical-grade silicon with hydrogen chloride, comprising: introducing said crude gas into a circulated suspension of metal chlorides in chlorosilanes, whereby the temperature of the crude gas is reduced from its introduction temperature to the temperature of the three-phase gas/liquid/solid mixture formed upon introduction of the crude gas into the suspension, partly by direct cooling resulting from vaporization of chlorosilanes and partly by indirect cooling,
recirculating part of the resulting suspension of metal chlorides in liquid chlorosilanes to the introduction point of the crude gas, and
separating metal chlorides from the remainder of the suspension.

2. The process of claim 1, which is carried out continuously or semicontinuously.

3. The process of claim 1, which is carried out under atmospheric pressure or superatmospheric pressure up to about 5 bar.

4. The process of claim 1, wherein the gaseous reaction mixture is introduced at high velocity into the circulated liquid suspension of metal chlorides in chlorosilanes.

5. The process of claim 1, wherein the gaseous reaction mixture is introduced into the suspension at such a velocity and in such an amount per unit time that a linear velocity of the gas/liquid/solid mixture of at least 2 m/s results.

6. The process of claim 5, wherein the linear velocity is from 2 to 8 m/s.

7. The process of claim 1, wherein the metal chlorides are removed from the unrecirculated part of the suspension by passing the suspension to a filtration apparatus in which the metal chlorides and chlorosilanes are separated under pressure.

8. The process of claim 6, wherein the solid metal chlorides are separated from their suspension in chlorosilanes by separating the suspension into a solid phase and a liquid phase in the absence of air and moisture in a zone which has been made inert, optionally under pressure, the solid phase is broken up in a zone which has been made inert, the broken-up solid phase is passed to a dissolution zone in which the metal chlorides are dissolved to form an aqueous metal chloride solution, and the individual chlorosilanes are isolated from the liquid phase by distillation.

9. The process of claim 1, wherein silicon dust and part of the metal chlorides are separated off dry by means of cyclones or filtration devices from the crude gas before it is introduced into the suspension of metal chlorides in chlorosilanes.

10. An apparatus for the condensation of the chlorosilanes and metal chlorides from crude gas from a reaction of technical-grade silicon with hydrogen chloride, comprising: a hollow vessel having a taper in the lower part; an external circulation pipe; a crude gas inlet port; a heat exchanger located in the hollow vessel; an overflow port and a gas offtake port.

11. The apparatus of claim 10, wherein said hollow vessel has a cylindrical crosssection and a conical taper in the lower part.

12. A filtration and dissolution apparatus for the separation and treatment of metal chlorides as described in claim 1, comprising: a gastight filtration chamber; a filtration apparatus enclosed therein; a feed line for the suspension; an offtake for liquid chlorosilanes; a conveying device for the granulated filter cake and a dissolution vessel having a feed line for water or hydrochloric acid and an offtake for metal chloride solution.

13. The apparatus claim 10, wherein the filtration apparatus is a filter press.

14. A process for separating metal chlorides from chlorosilanes, comprising:
means for introducing a hot, gaseous reaction mixture (crude gas) formed by the reaction of technical grade silicon with hydrogen chloride, into a circulated suspension of metal chlorides in chlorosilanes, whereby the temperature of the crude gas is reduced to the temperature of the three-phase gas/liquid/solid mixture formed upon introduction of the crude gas into the suspension, said temperature reduction step occurring partly by direct cooling resulting from vaporization of chlorosilanes and partly by indirect cooling,
means for recirculating a part of the resulting suspension of metal chlorides to the introduction point of the crude gas, and
means for separating metal chlorides from the remainder of the suspension.

15. The process of claim 13, which is carried out continuously or semicontinuously.

16. The process of claim 13, which is carried out under atmospheric pressure or superatmospheric pressure up to about 5 bar.

17. The process of claim 13, wherein the gaseous reaction mixture is introduced at high velocity into the circulated liquid suspension of metal chlorides in chlorosilanes.

18. The process of claim 13, wherein the gaseous reaction mixture is introduced into the suspension at such a velocity and in such an amount per unit time that a linear velocity of the gas/liquid/solid mixture of at least 2 m/s results.

19. The process of claim 17, wherein linear velocity of from 2 to 8 m/s results.

20. The process of claim 13, wherein the metal chlorides are removed from the unrecirculated part of the suspension by passing the suspension to a filtration apparatus in which the metal chlorides and chlorosilanes are separated under pressure.

21. The process of claim 17, wherein the solid metal chlorides are separated from their suspension in chlorosilanes by separating the suspension into a solid phase and a liquid phase in the absence of air and moisture in a zone which has been made inert, optionally under pressure, the solid phase is broken up in a zone which has been made inert, the brokenup solid phase is passed to a dissolution zone in which the metal chlorides are dissolved to form an aqueous metal chloride solution, and the individual chlorosilanes are isolated from the liquid phase by distillation.

22. The process of claim 13, wherein silicon dust and part of the metal chlorides are separated off dry by means of cyclones or filtration devices from the crude gas before it is introduced into the suspension of metal chlorides in chlorosilanes.
